(19) United States
(12) Patent Application Publication
(10) Pub. No.: US 2011/0053590 A1
(43) Pub. Date: Mar. 3, 2011

(54) DEFINING THE INITIATOR FOR A CONFIGURATION OR A SET OF OF AN ACCESS NETWORK CONNECTION

(75) Inventors: Thomas Belling, Erding (DE); Mirko Schramm, Berlin (DE)

(73) Assignee: Nokia Siemens Networks GmbH & Co. KG

(21) Appl. No.: 12/310,111

(22) PCT Filed: Aug. 6, 2007
(86) PCT No.: PCT/EP2007/058145

§ 371 Date: Feb. 11, 2009

(30) Foreign Application Priority Data
Aug. 11, 2006 (EP) 06016826.7
Aug. 24, 2006 (EP) 06017658.3

(51) Int. Cl. H04W 60/00

(52) U.S. Cl. 455/435.1

(57) ABSTRACT

Devices and methods initiate the structuring or the configuration of an access network connection for an access of a terminal to a telecommunications network, such as a cellular mobile radio network. Before the structuring or configuration of the telecommunications network, it is decided whether this structuring or this configuration of the access network connection should be initiated through the telecommunications network or through the terminal, and that the terminal is notified of this decision by the telecommunications network in one or more messages.

### BACKGROUND OF THE INVENTION

The invention relates to a method and a device for initiating the set up of an access network connection for an access of a terminal to a telecommunication network (called network for short in the text which follows), particularly a cellular mobile radio network.

Access connections from a terminal to a mobile radio, data and/or voice telephony network can be set up and/or configured by the terminal or by the network. In the case of networks in which the available resources in the access network are restricted such as, for example, in the case of mobile radio networks, it is desirable to configure the access connection (in a 3GPP network, for example, a so-called “PDP Context” of a GPRS network, or a so-called “Radio Access Bearer” of a UTRAN or GERAN radio network) in accordance with the requirements of the service currently used such as, for example, a VoIP telephone call, or a so-called “video streaming” application. The quality of service is thus intended to be adapted to the requirements of the currently used services with respect to bandwidth and with respect to other parameters influencing the quality of service such as maximum time delay during the packet transport and maximum rate of packet loss, which are frequently combined by means of a so-called QoS class. Within the network, for example, the so-called “Internet Multimedia Subsystem” (IMS), which is standardized in 3GPP TS 23.228, can be used for conveying the service and application server for producing the service. The IMS is originally designed as generic network which, for providing a multiplicity of services, offers the necessary functionality such as, for example, switching or authentication and is thus intended to provide for the introduction of new services without adaptations in the network.

The adaptation of the access network connection with respect to the requirements of the service or services currently used can be initiated either by the terminal or by the network. The adaptation by the terminal has the advantage that the terminal accurately knows the requirements of the services in every case. This is of advantage particularly for new or little used services since no special support of the services is then required in the network. On the other hand, problems can arise if the application is not set up for configuring the access network connection, for example because it only uses simple generic programming interfaces (APIs) which do not support a configuration of the access connection, or only to a restricted extent, or because the terminal is composed of a part which terminates and controls the access network connection, for example a mobile telephone, and another part on which the service is executed, for example a notebook, and the interface between the two parts again does not support the configuration of the access network connection, or only to a restricted extent. In addition, a faulty or maliciously programmed terminal can request unnecessarily large resources for a service and thus impair the access network. Besides, a set up of the access network connection by the network can frequently take place already in parallel with the service signaling, whereas the set up by the terminal frequently occurs only after the conclusion of the service signaling and thus more slowly. For these reasons, many network operators wish to be able to adjust the access network connections in accordance with the requirements of the service for important services by the network.

The “General Packet Radio Service” (GPRS) access network which is standardized in 3GPP TS 23.060 hitherto only provides the set up of PDP contexts initiated by mobile terminals.

It is the object of the invention to optimize a set up and/or a configuration of an access network connection in a downward-compatible and error-avoiding manner, if possible. The object is achieved in each case by the subject matters of the independent patent claims.

The present invention makes it possible in a downward-compatible and fault-cases-excluding manner that the network configures access network connections for particular services whilst the terminal configures the access network connections for other services.

It is also possible that, at the same time, both those services for which the network sets up or configures the access network connection(s) and those services for which the terminal sets up or configures access network connection(s) are used by one terminal.

For 3GPP mobile radio networks, it is conceivable to negotiate, when a terminal is registered in the GPRS network, whether the terminal supports the new network-initiated set up of PDP contexts. If the terminal supports this set up, it should be used exclusively for the terminal. However, the terminal would thus be able to use only services supported especially by the network. It is also conceivable that it is configured both in all terminals and also in the network by the network operator for each service whether the set up or the configuration of PDP contexts is to be initiated by the network or the terminal for this service. Thus, considerable configuration effort would again be required with the introduction of new services.

When a new service is started, signaling with respect to the service is first exchanged between the terminal and the network. For example, the so-called “Session Initiation Protocol” (SIP), IETF RFC 3261, and the so-called “Session Description Protocol” (SDP), IETF RFC 4566 or 2327, embedded therein, is used for this signaling as part of the IMS.

An essential aspect of the invention can be seen in the fact that the network first informs the terminal as part of the signaling, e.g. at the start of the service, whether the network will set up or configure the access network connection(s) for this service or individual components of this service (for example the media stream for voice or the media stream for video of a video telephony service), and then sets up an access network connection(s) suitable for the service or these individual components of this service by means of signaling of the access network, and that the terminal decides by means of the notification within the signaling for setting up the service whether it sets up or configures itself an access network connection(s) suitable for the service or these individual components of this service.

If the network informs the terminal that it itself will set up an access network connection suitable for the service or individual components of this service, the mobile terminal waits to receive signaling of the access network with respect to the setting up or configuration of one or more access network connection(s) suitable for the service or these individual components of this service, and then uses these access network connections for transmitting and/or receiving data streams allocated to the service or these individual components of this service. This avoids an additional signaling load and unnecessary occupation of resources in the access network and a possible faulty connection clear-down: it is avoided that network and terminal simultaneously set up access network connections for the service or for these individual components of this service. This would lead to an increased signaling load being produced in the access network and unnecessarily many resources being reserved at least temporarily. Besides, connection could be terminated if both terminal and network again find that the access network connections necessary for the service or for these individual components of this service exist twice and then simultaneously initiate the clearing-down of redundant connections. If network and terminal in each case select other connections for the clearing-down, the connection could be interrupted completely.

The network informs the terminal by means of packet filters conveyed via the signaling of the access network and in each case allocated to an access network connection and provided with priorities, which packet filters can contain IP addresses and port number of transmitter and receiver of the data streams, “Traffic Flow Templates” (TFT), which data streams are to be transported in which access network connection set up or configured by the network. The network sends such TFTs only for data streams which belong to services or to individual components of services for which the network sets up or configures the mobile access connection. But on the other hand, the terminal must also distribute other data streams sent by it to access network connections. The terminal preferably uses the TFTs transmitted by the network only for the allocation of those data streams which belong to services or to individual components of services for which the network has previously informed the terminal by means of service signaling that it will set up or configure access network connection(s). This avoids conflicts, which are otherwise possible between the allocation of data streams to access network connections according to the TFTs sent by the network and the allocation according to an internal algorithm in the terminal as required for services or for individual components of services for which the terminal itself sets up or configures the access network connections, arising in the terminal.

If the network informs the terminal that it will not set up or configure an access network connection for the service or for individual components of the service, the terminal itself initiates the set up or the configuration of suitable access network connections.

Within the framework of GPRS which hitherto has only provided the set up and the configuration of access network connections by the terminal, it is advantageous if the terminal informs the network already at the time of the GPRS registration that it supports the set up and the configuration of access connections, and the inventive notification in the signaling with respect to the service or for individual components of the service whether the network will set up or configure the access network connection(s) for this service or for these individual components of the service. It is only when the network receives a corresponding notification during the GPRS registration that the network can decide to set up itself the access network connections for a service or for individual components of a service and send to the terminal the corresponding inventive notification in the signaling with respect to the service or with respect to individual components of the service. For reasons of downward compatibility, it is also advantageous if an inventive notification is only sent in the signaling with respect to the service or with respect to individual components of the service if the network itself sets up or configures the access network connections for the service. If, in contrast, the network decides that the terminal itself is to set up or configure the access network connections for the service, the network preferably does not send any notification in the service signaling. This corresponds to the behavior of an older GPRS access network which does not support the notification and expects that the terminal itself sets up or configures the access network connections for the service. A terminal connected to the GPRS access network always sets up or configures the access network connection(s) for a service or for individual components of the service itself if it does not receive a notification from the network with respect to the service or with respect to individual components of the service.

In other types of access networks than GPRS, it may be advantageous to provide a different behavior for the terminal if it does not receive a notification in the service signaling whether network or terminal set up or configure the access network connections for a service or for individual components of the service. Thus, in WIMAX, only the set up or the configuration of access network connections by the network will be possible initially. Should the additional possibility of a set up of access network connections by the terminal be provided, it is advantageous if a terminal uses this possibility only if it receives a corresponding request in the service signaling. If the service signaling does not contain any notification about whether the access network connections for the service or for individual components of the service are set up or configured by network or terminal, the terminal should wait for the network to perform the set up or the configuration.

The decision of the network whether the access network connection is set up by the network or by the terminal can depend on the type of service or of the individual components of the service. In addition, it can depend on the type and the capabilities of the access network or the rights granted to a user by an operator. Preferably, the set up or the configuration of the access network connections is selected by the terminal at least in the case of services unknown to the network or in the case of individual unknown components of a service.

Within the network, the set up of the access network connections is controlled by the so-called “Policy and Charging Rules Function” (PCRF) which is standardized in 3GPP TS 23.203. The PCRF is connected via the so-called Gx interface to a so-called “Policy and Charging Enforcement Function” (PCEF) which, in the case of GPRS, is located within the so-called “Gateway GPRS Support Node” (GGSN) which connects the access network to another packet network such as, for example, the IMS core network or the Intranet. The PCRF is connected via the so-called Rx interface to a so-called “Application Function” (AF) which is involved in signaling with respect to the start of services and supplies the PCRF with information about the service. For example, the so-called “Proxy Call Session Control Function” (P-CSCF) is used as AF in the IMS. The P-CSCF forwards SIP signaling for the control of services between IMS and terminal and forwards information with respect to the service, derived from the embedded SDP, particularly about the type of media streams (as components of the service) and of the codecs used for them, to the PCRF.

It is advantageous if the PCRF makes the decision whether it is the network or the terminal which is to set up or configure access network connections for a service or for individual components of a service for the network since the PCRF is a central location (or the central location) for the administration of rules (policies) of the network operator and can also request special adjustments with respect to the service for individual users via an interface with the user database. If the PCRF receives information with respect to new services from an AF, the PCRF informs the AF in response whether it is the network or the terminal which is to set up or configure the access network connections for this service or for individual components of the service. The AF then forwards this notification to the terminal in the signaling with respect to the service. If the network sets up the access network connections, the PCRF then initiates the set up or the configuration of an access network connection for the service or services via the Gx interface. Otherwise, the PCRF authorizes the set up or the configuration of access network connections for the service or for the individual components of the service through the terminal.

If SIP is used for the signaling with respect to the service, it is advantageous to convey the notification whether or that the network sets up or configures the access network connections within a new so-called SIP header. This provides for a notification which relates to the entire service. As an alternative, a new attribute which contains this notification can be defined in the embedded SDP. Signaling in the SDP has the advantage that different decisions can be notified here for individual media streams as components of a service which are negotiated in the same SIP message.

The invention makes it possible that it is decided in accordance with service-dependent rules configured by the operator whether access network connections are set up by the network or the terminal for certain services or for certain components of services. As a result, the operator retains maximum control over the resources used in the access network, especially for much used services or components of services, on the one hand, and, on the other hand, it is avoided that adaptations are required in the network for new or little used services or components of services. It is made possible that the corresponding decision rules are deposited by the operator only at a few control nodes (e.g. PCRF). An elaborate configuration of terminals is avoided. It is also avoided that network and terminal simultaneously set up or configure access network connections for a service or the same components of a service which could lead to an additional signaling load and unnecessary occupation of resources in the access network and to a loss of the connection.

Further features and advantages of the invention are obtained from the patent claims and the subsequent description of an exemplary embodiment, referring to the drawing, in which:

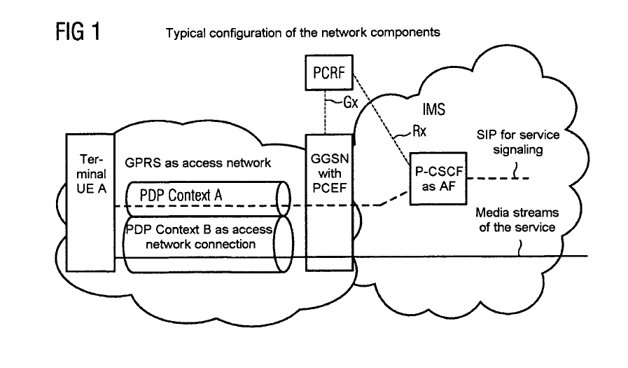

FIG. 1 shows a typical configuration of network components of a telecommunication network,

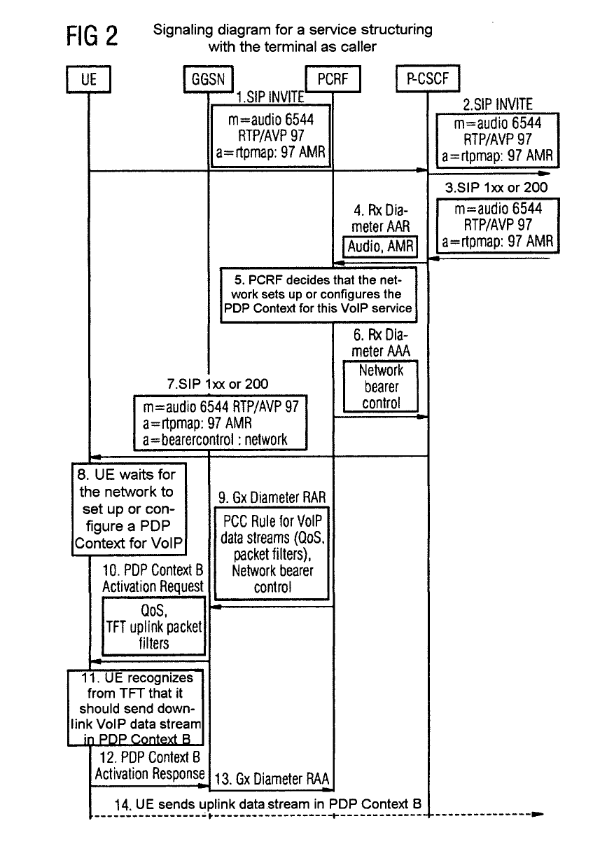

FIG. 2 shows a signaling diagram for a service set up with the terminal as caller and

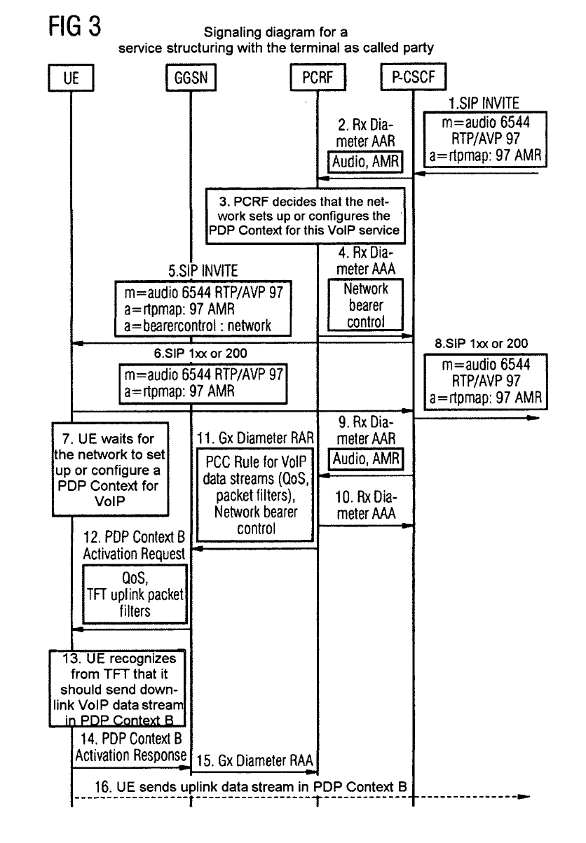

FIG. 3 shows a signaling diagram for a service set up with the terminal as called party.

FIG. 1 shows a typical configuration of network components of a telecommunication network. It shows a mobile terminal UE, a Gateway GPRS Support Node GGSN with Policy and Charging Enforcement Function PCEF, a Policy and Charging Rules Function PCRF and a Proxy Call Session Control Function P-CSCF as application function AF within an Internet Multimedia Subsystem IMS. The terminal UE uses two PDP Contexts A and B as access network connections to the GGSN through the mobile access network GPRS. In PDP Context A, SIP signaling is transported with respect to a service such as, for example, VoIP, between UE and P-CSCF. P-CSCF forwards this signaling to and from the IMS, respectively. PDP Context B is used as access network connection for the service.

FIG. 2 shows a signaling diagram for a service set up with the terminal as caller. It shows messages between the nodes shown in FIG. 1 and other elements which are used in the set up of a VoIP telephone call, the subscriber at the terminal UE being the caller. Only selected SIP messages promoting the understanding of the invention are shown. In detail, the message flow is as follows:

The UE sends an SIP INVITE message and describes a VoIP service in the embedded SDP.
The SIP INVITE message is forwarded by the P-CSCF.
The P-CSCF receives an SIP response message which contains embedded SDP, for example a 183 Session Progress message, a 180 Ringing message or a 200 OK(INVITE) message.

The P-CSCF informs the PCRF by means of a diameter AAR message via the Rx interface about the set up of a new service and describes the service by means of parameters which are derived from the SDP received in messages 1 and 3.

According to the invention, the PCRF decides that the network sets up or configures the PDP Context for this VoIP service.

The PCRF sends a Diameter AAA message via the Rx interface to the P-CSCF and, according to the invention, informs by means of a new parameter that the network sets up or configures the PDP Context for the service specified in message 4.

The P-CSCF forwards the SIP response message received in step 3. In the SDP contained, the P-CSCF, according to the invention, inserts, on the basis of the information received in message 6, a new SDP attribute “a=bearercontrol:network”, which specifies for the VoIP media stream that it should use an access network connection set up or controlled by the network.

On the basis of the information received in message 7, the terminal decides not to set up or configure itself a PDP Context for this service but to wait for GPRS-specific signaling about PDP contexts set up or modified by the network.

The PCRF, by means of a Diameter RAR message sent via the Gx interface, causes the GGSN to set up or to configure a PDP Context for the new service. For this purpose, the PCRF sends one or more so-called “PCC Rules”, suitable for the VoIP service, which contain packet filters and information on the required quality of service, and a notice that the GGSN is to set up or configure a suitable PDP Context for these PCC rules.

On the basis of the information contained in message 9, the GGSN decides to set up the new PDP Context B and for this purpose sends a “PDP Context Activation Request message” which contains information on the required quality of service and TFT filters for data streams in the uplink direction. These packet filters are derived from the filters in message 9.

From the received TFT, the UE recognizes that it is intended to send uplink data streams for the new VoIP service in PDP Context B.

The UE sends a “PDP Context Activation Response” message for concluding the set up of PDP Context B.

The GGSN sends a Diameter RAR message via the Gx interface.

The UE begins to send uplink data streams for the new VoIP service in PDP Context B.

FIG. 3 shows a signaling diagram for a service set up with the terminal as called party. It shows messages between the nodes shown in FIG. 1 which are used in the set up of a VoIP telephone call, the subscriber at the terminal UE being the caller. Only selected SIP messages are shown. In detail, the message flow is as follows:

The P-CSCF receives an SIP INVITE message with embedded SDP which describes a VoIP service.
The P-CSCF informs the PCRF by means of a Diameter AAR message via the Rx interface about the set up of a new service and describes the service by means of parameters which are derived from the SDP received in message 1.

According to the invention, the PCRF decides that the network sets up or configures the PDP Context for this VoIP service.

The PCRF sends a Diameter AAA message via the Rx interface to the P-CSCF and, according to the invention, informs by means of a new parameter that the network sets up or configures the PDP Context for the service specified in message 2.

The SIP INVITE message 1 is forwarded by the P-CSCF. In the SDP contained, the P-CSCF, according to the invention, inserts, on the basis of the information received in message 6, a new SDP attribute “a=bearercontrol:network” which specifies for the VoIP media stream that it should use an access network connection set up or controlled by the network.

The UE sends an SIP response message which contains embedded SDP, for example a 183 Session Progress message, a 180 Ringing message, or a 200 OK(INVITE) message, and thus continues the set up of the VoIP service. The SDP contains information on own addresses of the UE and selected codecs.

On the basis of the information received in message 5, the terminal decides not itself to set up or to configure a PDP Context for this service but to wait for GPRS-specific signaling via PDP Contexts set up or modified by the network.

The P-CSCF informs the PCRF by means of a Diameter AAR message via the Rx interface about the continuation of the set up of the new service from message 2 and supplements the description of the service by means of parameters which are derived from the SDP received in message 7.

The PCRF sends a Diameter AAA message via the Rx interface to the P-CSCF in order to acknowledge message 8.

The P-CSCF forwards the SIP response message received in step 6. to 16. As for messages 9.-14. in FIG. 2.

1. A method for controlling the initiating of the set up or the configuration of one or more access network connections for an access of a terminal to a telecommunication network, wherein before the set up or the configuration, the telecommunication network decides whether this set up or this configuration of the access network connection is to be initiated by the telecommunication network or by the terminal, and wherein the terminal is informed of this decision by the telecommunication network in one or more messages,
and wherein the decision is made in accordance with predefined rules which specify for particular services or particular components of services that a set up or a configuration of access network connections is to be triggered for these services or components by the telecommunication network.

2. The method as claimed in claim 1, wherein the decision whether the set up or the configuration of the one or more access network connections is to be triggered by the telecommunication network or by the terminal refers to one or more services or components of services, particularly to services or components of services, the set up or changing of which is initiated by the exchange of signaling between network and terminal at the time of the decision.

3. (canceled)

4. The method as claimed in claim 1, wherein for unknown services for which there are no predefined rules in existence, it is decided that the terminal initiates the set up or the configuration of access network connections.

5. The method as claimed in claim 1, wherein the decision of the telecommunication network as to whether the access network connection is set up by the telecommunication network or the terminal depends on the type and the capabilities of the access network or on the rights granted to a user by an operator.

6. The method as claimed in claim 1, wherein for parts of a service, the telecommunication network initiates the set up or the configuration, whereas for other parts of this service, the terminal initiates the set up or the configuration.

7. The method as claimed in claim 1, wherein one or more elements of the telecommunication network decide whether a set up of the access network connection is to be triggered by the telecommunication network or the terminal.

8. The method as claimed in claim 1, wherein when a service or one or more components of a service is/are started or changed, signaling with respect to the service is first exchanged between the terminal and the telecommunication network, particularly with the “Session Initiation Protocol” SIP or the “Session Description Protocol” (SDP).

9. The method as claimed in claim 1, wherein the notification to the terminal whether a set up of the access network connection is to be triggered by the telecommunication network or the terminal is conveyed to the terminal as part of the signaling for the start or of the modification of the service or of the components of the service.

10. The method as claimed in claim 1, wherein the terminal decides whether it itself sets up or configures an access network connection(s) suitable for the service by means of a notification whether the set up or the configuration of the one or more access network connections is to be triggered by the telecommunication network or by the terminal.

11. The method as claimed in claim 1, wherein if the telecommunication network notifies the terminal that it itself will set up an access network connection suitable for the service, the mobile terminal waits to receive signaling of the access network with respect to the setting up or configuring of one or more access network connection(s) suitable for the service and then uses these access network connections for transmitting or receiving data streams allocated to the service.

12. The method as claimed in claim 1, wherein it is avoided that the telecommunication network and the terminal simultaneously set up access network connections for the same service.

13. The method as claimed in claim 1, wherein the telecommunication network informs the terminal by means of packet filters conveyed via the signaling of the access network and in each case allocated to an access network connection and provided with priorities, which packet filters can contain IP addresses and port number of transmitter and receiver of the data streams (“Traffic Flow Templates TFT”), which data streams are to be transported in which access network connection set up or configured by the telecommunication network.

14. The method as claimed in claim 12, wherein the telecommunication network sends such TFTs only for data streams which belong to services or components of services for which the telecommunication network sets up or configures the mobile access connection.

15. The method as claimed in claim 1, wherein the terminal uses the TFTs transmitted by the telecommunication network only for the allocation of those data streams which belong to services or components of services for which the telecommunication network has previously informed the terminal by means of service signaling that it will set up or configure at least one access network connection.

16. The method as claimed in claim 1, wherein if the telecommunication network informs the terminal that it will not set up or configure an access network connection for the service, the terminal itself initiates the set up or the configuration of suitable access network connections.

17. The method as claimed in claim 1, wherein for a GPRS access connection, the terminal informs the telecommunication network already at the time of the GPRS registration that it supports the set up and the configuration of access connections and understands the notification of the network whether the telecommunication network or the terminal is to set up or configure the access network connection(s).

18. The method as claimed in claim 16, wherein only when the telecommunication network receives a corresponding notification during the GPRS registration, the telecommunication network decides to set up access network connections itself and then sends one or more corresponding notifications to the terminal.

19. The method as claimed in claim 1, wherein a notification whether access network connections are set up by the network or by the terminal is sent only when the telecommunication network itself sets up or configures the access network connections for the service, particularly if GPRS is used as the access network.

20. The method as claimed in claim 1, wherein the terminal, when it does not receive a notification whether access network connections are set up by the network or by the terminal, itself sets up access network connections, particularly if GPRS is used as the access network.

21. The method as claimed in claim 1, wherein session initiation protocol is used for signaling with respect to the service, and in that the notification whether the terminal or telecommunication network sets up or configures the access network connections is conveyed within an SIP header.

22. The method as claimed in claim 1, wherein the notification whether the terminal or the telecommunication network sets up or configures the access network connections is conveyed within an SDP attribute.

23. A device for initiating the set up of an access network connection in a telecommunication network, said device comprising:
a decision device for deciding before the set up of an access network connection whether the set up or the configuration of the access network connection is to be initiated by the telecommunication network or the terminal, and
a memory for rules for services, which rules specify whether an access network connection is in each case set up or configured by the telecommunication network or by the terminal for a particular service.

24. (canceled)

25. The method as recited in claim 1, said method controlling an access of the terminal to a cellular mobile radio network.

26. The device as recited in claim 23, wherein said the device is configured to initiate set up of an access network connection in a cellular mobile radio network.
